(19) United States
(12) Patent Application Publication
(10) Pub. No.: US 2026/0336373 A1
(43) Pub. Date: Oct. 29, 2026

(54) VEHICLE TIRE RIM COVER FOR CLEANING VEHICLE TIRES AND A METHOD THEREFOR

(71) Applicant: Johnny Jones, Southfield, MI (US)

(72) Inventor: Johnny Jones, Southfield, MI (US)

(21) Appl. No.: 19/186,765

(22) Filed: Apr. 23, 2025

(51) Int. Cl. B60J 11/10; B05B 12/30; B60B 7/00

(52) U.S. Cl. CPC B60J 11/10; B05B 12/30; B60B 7/00; B60B 2900/211

(57) ABSTRACT

A vehicle tire rim cover includes a disc, a pair of handles, and a secondary handle. The disc is designed to cover a rim of a vehicle tire during cleaning of the vehicle tire. The handles are coupled to the disc at a central portion of the disc. The secondary handle is coupled to the disc. The secondary handle includes an elongated body having a first handle end and a second handle end. The secondary handle is pivotable with respect to the disc to position the second handle end on a surface adjacent the vehicle tire with the first handle end against the disc to prop the disc against the rim.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle tire rim cleaning devices and more particularly pertains to a new vehicle tire rim cover for covering a rim of a vehicle tire while cleaning the vehicle tire. When a user cleans a vehicle tire, the cleaning liquids can drip onto the rim, which is undesirable. Different types of shield devices can be used that are held in one hand while the user cleans the vehicle tire with another hand, which can be difficult if the user is elderly or has compromised grip strength or mobility. The vehicle tire rim allows for hands-free use so that the user can utilize both hands in cleaning the vehicle tire.

### (2) Description of Related Art Including Information Disclosed under 37 CFR 1.97 and 1.98

The prior art relates to vehicle tire rim cleaning devices. The prior art, as best understood, does not disclose a vehicle tire rim cover that includes a disc, a pair of handles, and a secondary handle. The disc is designed to cover a rim of a vehicle tire during cleaning of the vehicle tire. The secondary handle is pivotable with respect to the disc to position the second handle end on a surface adjacent the vehicle tire with the first handle end against the disc to prop the disc against the rim.

### BRIEF SUMMARY OF THE INVENTION

An embodiment of the disclosure meets the needs presented above in a vehicle tire rim cover generally comprising a disc, a pair of handles, and a secondary handle. The disc is designed to cover a rim of a vehicle tire during cleaning of the vehicle tire. The handles are coupled to the disc at a central portion of the disc. The secondary handle is coupled to the disc. The secondary handle includes an elongated body having a first handle end and a second handle end. The secondary handle is pivotable with respect to the disc to position the second handle end on a surface adjacent the vehicle tire with the first handle end against the disc to prop the disc against the rim.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicle tire rim cover according to an embodiment of the disclosure.

FIG. 2 is a top front perspective view of an embodiment of the disclosure.

FIG. 3 is a top rear perspective view of an embodiment of the disclosure.

FIG. 4 is a perspective view of an embodiment of the disclosure.

FIG. 5 is a perspective view of an embodiment of the disclosure in use.

FIG. 6 is a perspective view of an embodiment of the disclosure in use.

FIG. 7 is a side view of an embodiment of the disclosure in use.

### DETAILED DESCRIPTION OF THE INVENTION

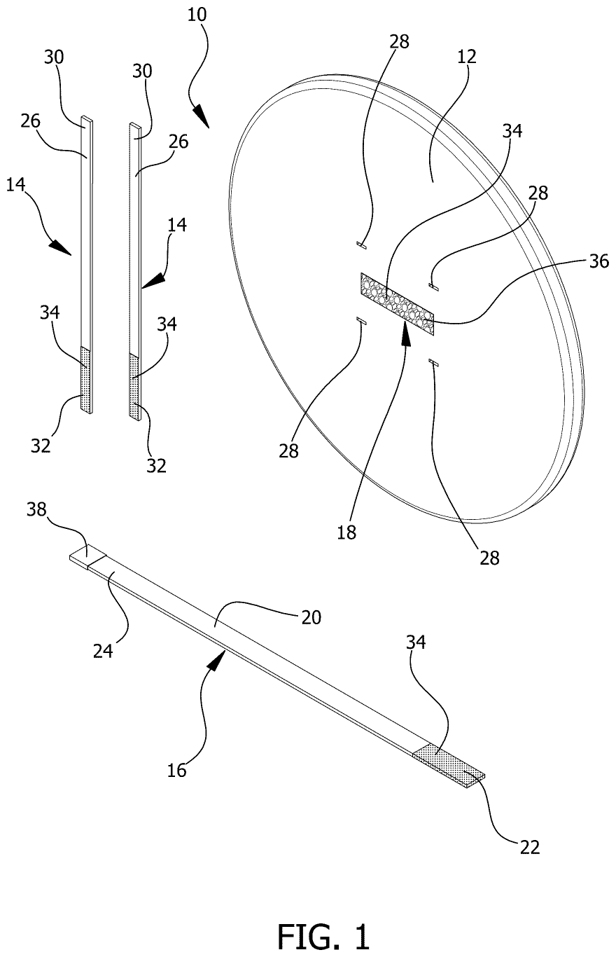

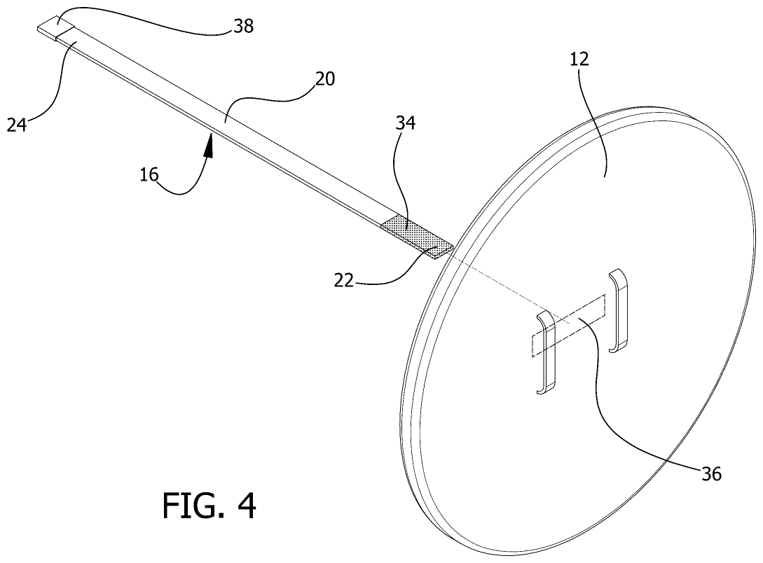

With reference now to the drawings, and in particular to FIGS. 1 through 7 thereof, a new vehicle tire rim cover embodying the principles and concepts of an embodiment of the disclosure and generally designated by the reference numeral 10 will be described.

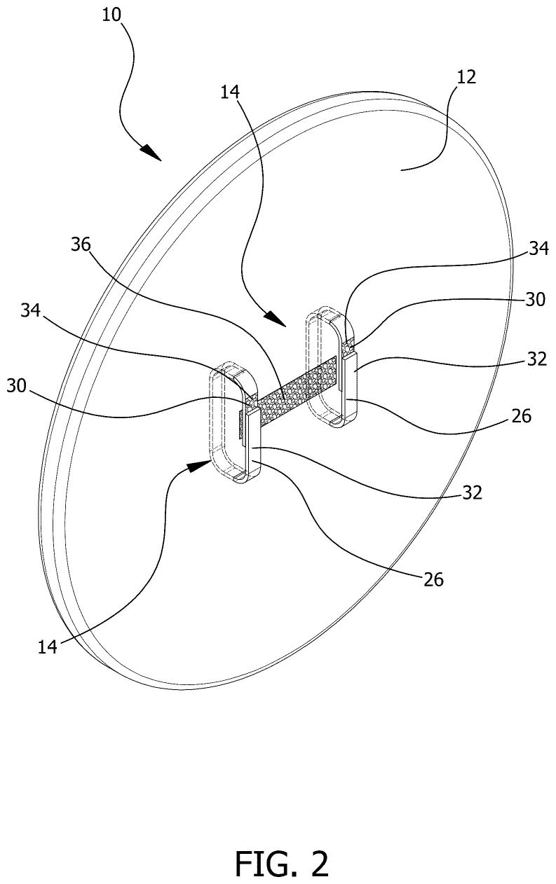

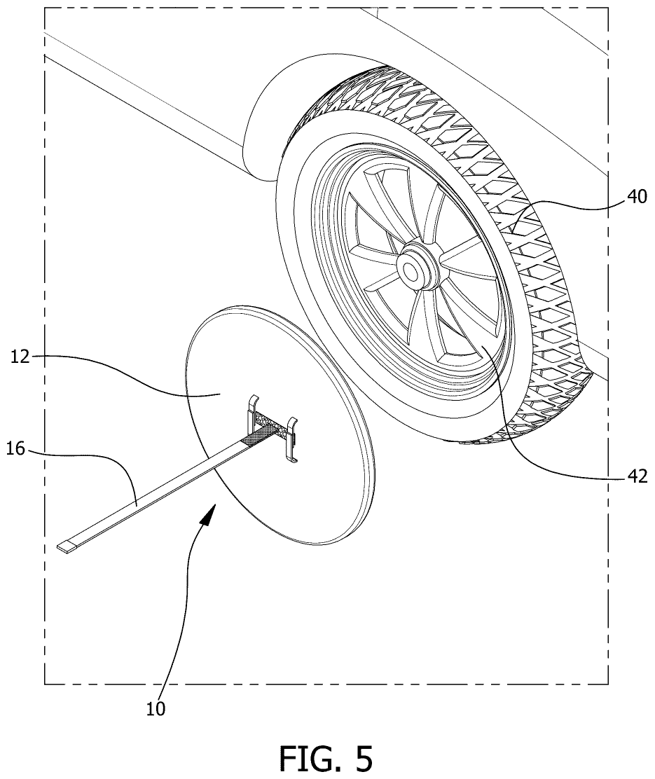

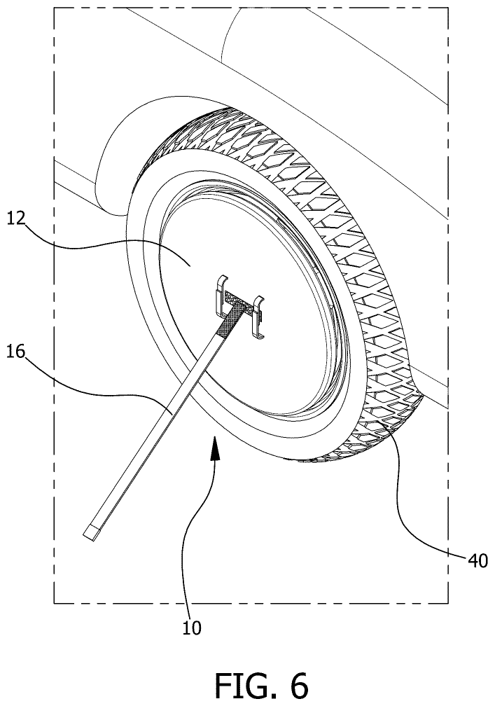

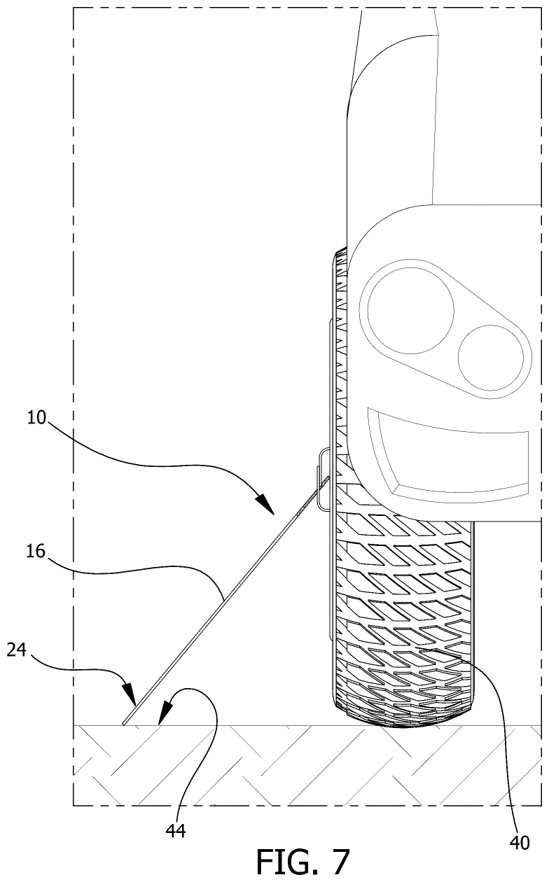

As best illustrated in FIGS. 1 through 7, the vehicle tire rim cover 10 generally comprises a disc 12, a pair of handles 14, and a secondary handle 16. FIG. 1 shows these components separated from one another. The disc 12 is designed to cover a rim 42 of a vehicle tire 40 during cleaning of the vehicle tire 40, as shown in FIGS. 6 and 7. As shown in FIG. 2, the handles 14 are coupled to the disc 12 at a central portion 18 of the disc 12. The secondary handle 16 is coupled to the disc 12. The secondary handle 16 includes an elongated body 20 having a first handle end 22 and a second handle end 24. As shown in FIGS. 5 and 6, the secondary handle 16 is pivotable with respect to the disc 12 to position the second handle end 24 on a surface 44 adjacent the vehicle tire 40 with the first handle end 22 against the disc 12 to prop the disc 12 against the rim 42.

In the exemplary embodiment in FIG. 2, each of the handles 14 includes a strap 26 projecting from the disc 12.

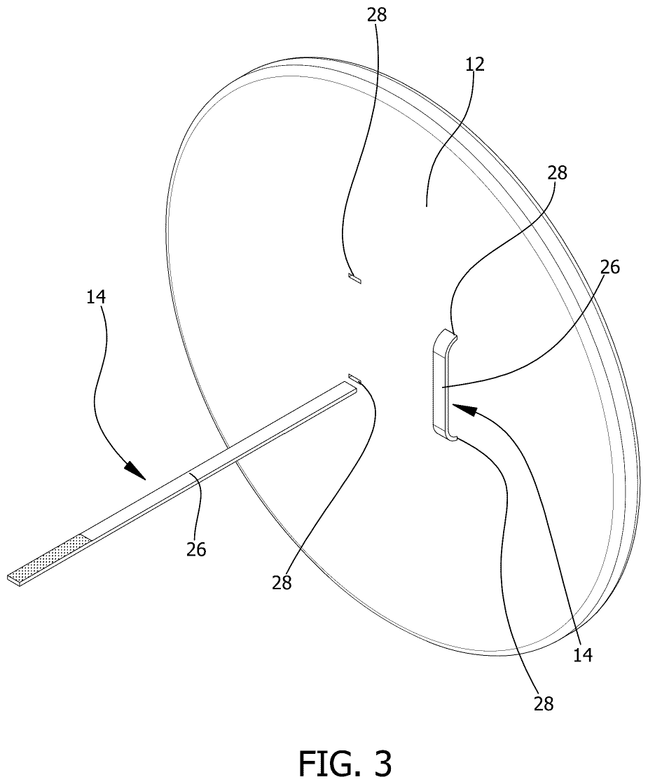

In the exemplary embodiment in FIG. 3, the disc 12 includes two pairs of slots 28. Each of the straps 26 is passed through a respective pair of the two pairs of slots 28 and formed into a loop. In another possible embodiment, the slots 28 could be omitted, and the straps 26 could be joined directly to the disc 12, such as by adhesive.

In the exemplary embodiment in FIG. 2, each of the straps 26 includes a first strap end 30 having hook-and-loop material 34 and a second strap end 32 having hook-and-loop material 34 to detachably couple the second strap end 32 to the first strap end 30. In this manner, the straps 26 can be formed into the loops.

In the exemplary embodiment in FIG. 1, the vehicle tire rim cover 10 further includes a piece 36 of hook-and-loop material 34 positioned on the central portion 18 of the disc 12, such as between the slots 28 as shown. The secondary handle 16 includes hook-and-loop material 34 at the first handle end 22 to connect to the piece 36 of hook-and-loop material 34 to detachably couple the secondary handle 16 to the disc 12. This design allows the secondary handle 16 to be freely positioned and pivoted at an angle with respect to the disc 12. In another possible embodiment, the secondary handle 16 could be permanently attached to the disc 12, such as by a hinge or a ball-and-socket joint. In the exemplary embodiment in FIG. 1, the secondary handle 16 includes a layer of grip material 38 on the second handle end 24. The grip material 38 is included to provide a gripping force on smooth surfaces, such as tile or concrete.

The disc 12 includes liquid-resistant material. In one possible embodiment, the disc 12 could be made of a lightweight metal, such as aluminum, or plastic, or could be made of paperboard or similar with a liquid-resistant coating.

FIGS. 5 through 7 show the use of the vehicle tire rim cover 10. With the vehicle tire rim cover 10, the user can grasp one or both of the handles 14 to hold the disc 12 over the rim 42 and clean the vehicle tire 40 with the free hand of the user. Alternatively, the user can angle the secondary handle 16 such that the second handle end 24 rests on the surface 44 adjacent the vehicle tire 40, as shown in FIGS. 6 and 7. The secondary handle 16 functions much like a motorcycle kickstand to prop the disc 12 against the rim 42. The user is now free to use both hands to clean the vehicle tire 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle tire rim cover comprising:
a disc, the disc being configured to cover a rim of a vehicle tire during cleaning of the vehicle tire;
a pair of handles, the handles being coupled to the disc at a central portion of the disc;
a secondary handle, the secondary handle being coupled to the disc, the secondary handle including an elongated body having a first handle end and a second handle end, the secondary handle being pivotable with respect to the disc to position the second handle end on a surface adjacent the vehicle tire with the first handle end against the disc to prop the disc against the rim.

2. The vehicle tire rim cover of claim 1, wherein each of the handles includes a strap projecting from the disc.

3. The vehicle tire rim cover of claim 1, wherein:
the disc includes two pairs of slots; and
each of the straps is passed through a respective pair of the two pairs of slots and formed into a loop.

4. The vehicle tire rim cover of claim 1, wherein each of the straps includes a first strap end having hook-and-loop material and a second strap end having hook-and-loop material to detachably couple the second strap end to the first strap end.

5. The vehicle tire rim cover of claim 1, further comprising a piece of hook-and-loop material positioned on the central portion of the disc, wherein the secondary handle includes hook-and-loop material at the first handle end to connect to the piece of hook-and-loop material to detachably couple the secondary handle to the disc.

6. The vehicle tire rim cover of claim 1, wherein the secondary handle includes a layer of grip material on the second handle end.

7. The vehicle tire rim cover of claim 1, wherein the disc comprises liquid-resistant material.

8. The vehicle tire rim cover of claim 2, wherein:
the disc includes two pairs of slots; and
each of the straps is passed through a respective pair of the two pairs of slots and formed into a loop.

9. The vehicle tire rim cover of claim 8, wherein each of the straps includes a first strap end having hook-and-loop material and a second strap end having hook-and-loop material to detachably couple the second strap end to the first strap end.

10. The vehicle tire rim cover of claim 9, further comprising a piece of hook-and-loop material positioned on the central portion of the disc, wherein the secondary handle includes hook-and-loop material at the first handle end to connect to the piece of hook-and-loop material to detachably couple the secondary handle to the disc.

11. The vehicle tire rim cover of claim 10, wherein the secondary handle includes a layer of grip material on the second handle end.

12. The vehicle tire rim cover of claim 11, wherein the disc comprises liquid-resistant material.

13. A method of cleaning vehicle tires, the method comprising the steps of:
providing a vehicle tire rim cover comprising:
a disc, the disc being configured to cover a rim of a vehicle tire during cleaning of the vehicle tire;
a pair of handles, the handles being coupled to the disc at a central portion of the disc;
a secondary handle, the secondary handle being coupled to the disc, the secondary handle including an elongated body having a first handle end and a second handle end, the secondary handle being pivotable with respect to the disc to position the second handle end on a surface adjacent the vehicle tire with the first handle end against the disc to prop the disc against the rim;
placing the disc over a rim of a vehicle tire;
angling the secondary handle with respect to the disc and positioning the second handle end on a surface adjacent the vehicle tire with the first handle end against the disc to prop the disc against the rim; and
using both hands to clean the vehicle tire.
